(19) United States
(12) Patent Application Publication
(10) Pub. No.: US 2015/0019260 A1
(43) Pub. Date: Jan. 15, 2015

(54) METHODS AND SYSTEMS FOR PRESENTING MEDICAL INFORMATION

(71) Applicants: Kyle Samani, Austin, TX (US); Patrick Kolencherry, Austin, TX (US)

(72) Inventors: Kyle Samani, Austin, TX (US); Patrick Kolencherry, Austin, TX (US)

(73) Assignee: PRISTINE, Austin, TX (US)

(21) Appl. No.: 14/324,332

(22) Filed: Jul. 7, 2014

Related U.S. Application Data
(60) Provisional application No. 61/844,018, filed on Jul. 9, 2013.

(51) Int. Cl. G06F 19/00

(52) U.S. Cl. CPC G06F 19/322
USPC 705/3

(57) ABSTRACT

Embodiments described herein disclose methods and systems to automatically transmit medical information to medical practitioners. The transmitted medical information may be a sub-set of information of a patient's medical health record that is desired to be viewed by the medical practitioner based on the medical practitioner's location, schedule, and/or the patient's medical status.

### CROSS-REFERENCE TO RELATED APPLICATIONS

This application claims a benefit of priority under 35 U.S.C. §119 to Provisional Application No. 61/844,018 filed Jul. 9, 2013, which is fully incorporated herein by reference in its entirety.

### BACKGROUND INFORMATION

1. Field of the Disclosure

Examples of the present disclosure are related to techniques for presenting medical information to medical practitioners. Specifically, embodiments may present relevant information to medical practitioners responsive to a variety of contexts, including but not limited to the medical practitioners' location, schedule, and/or a patient's medical status.

2. Background

Health records are documentations of a patient's medical history. Health records may include a variety of medical information generated by medical practitioners and/or medical computing devices over a period of time. The generated medical information may include recorded observations, administration of drugs and therapies, operations performed on the patient, medical history of the patient's family, etc.

When medical practitioners diagnose a patient they are required to review the patient's health record. Conventionally, to access a patient's health record, a medical practitioner accesses a computing device, enters commands to search for a specific patient, determines the health records associated with the patient, and reviews the patient's entire health record to identify relevant information.

By receiving the patient's entire health record, the medical practitioner may be inundated with medical information that the medical practitioner does not desire to view. Therefore, the medical practitioner may have to expend additional and costly time to review the patient's medical history to determine what information is relevant.

Furthermore, by requiring the medical practitioner to enter commands on the computing device, the medical practitioner's hands may become unsanitary due to the medical practitioner's interaction with the computing device. Therefore, the medical practitioner may be required to sanitize their hands after each search for a patient's medical history, which requires additional time.

Accordingly, needs exist for more efficient methods and systems to automatically present relevant medical information to a medical practitioner responsive to the location of the medical practitioner, the schedule of the medical practitioner, and the patient's medical status.

### SUMMARY

Embodiments disclosed herein provide systems and methods to automatically transmit medical information to nurses, doctors, or other medical practitioners (referred to individually and collectively hereinafter collectively as “medical practitioners”) during or preceding a point of care for a patient.

In embodiments, a medical logic server may be configured to receive medical information associated with at least one patient's medical history. The medical information may include medical procedures the patient has previously completed, upcoming medical procedures, lab results, a medical practitioner's diagnosis of a previous illness, reasons the patient is visiting the medical practitioner, etc. The received medical information may also be received from medical computing devices monitoring the patient in real-time, such as a heart rate monitor, blood pressure monitor, etc.

In embodiments, the medical information transmitted to a medical practitioner may be automatically transmitted based on information that the medical practitioner desires to be view at a certain time and/or location. The medical information may be transmitted responsive to determining the location of the medical practitioner, other medical practitioners proximate to the medical practitioner, the medical practitioner's profession, the medical practitioner's schedule, and/or a patient's medical status or reasons for visiting the medical practitioner.

In embodiments, the medical information may be transmitted to the medical practitioner without the medical practitioner performing commands on a client computing device to request the medical information.

In embodiments, the medical information may be received from at least one data source, and may include a patient's electronic health record. The medical logic server may be configured to perform data processing on the received medical information associated with the patient to analyze the medical information. The received medical information associated with a patient's medical health record may be tagged with contextual identifiers, wherein the contextual identifiers are associated with what medical information a medical practitioner may desire to receive (e.g., information based on the patient's last visit, diagnosis, schedule treatment, etc.). The medical information may also include contextual identifiers associated with when the medical practitioner may desire to receive the medical information (e.g., information based on the medical practitioner's schedule or location and/or a number of medical practitioner's in close proximity to each other).

These, and other, aspects of the embodiments will be better appreciated and understood when considered in conjunction with the following description and the accompanying drawings. The following description, while indicating various embodiments and numerous specific details thereof, is given by way of illustration and not of limitation. Many substitutions, modifications, additions or rearrangements may be made within the scope of the embodiments, and the embodiments include all such substitutions, modifications, additions or rearrangements.

### BRIEF DESCRIPTION OF THE DRAWINGS

Non-limiting and non-exhaustive embodiments are described with reference to the following figures, wherein like reference numerals refer to like parts throughout the various views unless otherwise specified.

FIG. 1 depicts one embodiment of a topology for automatically presenting medical information to a medical practitioner.

FIG. 2 depicts a method for presenting relevant and timely medical information to a medical practitioner.

FIG. 3 depicts a method for presenting relevant and timely medical information to a medical practitioner.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present disclosure. Also, common but well-understood elements that are useful or necessary in a commercially feasible embodiment are often not depicted in order to facilitate a less obstructed view of these various embodiments of the present disclosure.

### DETAILED DESCRIPTION

In the following description, numerous specific details are set forth in order to provide a thorough understanding of the present embodiments. It will be apparent, however, to one having ordinary skill in the art that the specific detail need not be employed to practice the present embodiments. In other instances, well-known materials or methods have not been described in detail in order to avoid obscuring the present embodiments.

Reference throughout this specification to “one embodiment”, “an embodiment”, “one example” or “an example” means that a particular feature, structure or characteristic described in connection with the embodiment or example is included in at least one embodiment. Thus, appearances of the phrases “in one embodiment”, “in an embodiment”, “one example” or “an example” in various places throughout this specification are not necessarily all referring to the same embodiment or example. Furthermore, the particular features, structures or characteristics may be combined in any suitable combinations and/or sub-combinations in one or more embodiments or examples. In addition, it is appreciated that the figures provided herewith are for explanation purposes to persons ordinarily skilled in the art and that the drawings are not necessarily drawn to scale.

Embodiments may be embodied as an apparatus, method, or computer program product. Accordingly, the present embodiments may take the form of an entirely hardware embodiment, an entirely software embodiment (including firmware, resident software, micro-code, etc.), or an embodiment combining software and hardware aspects that may all generally be referred to herein as a “module” or “system.” Furthermore, the present embodiments may take the form of a computer program product embodied in any tangible medium of expression having computer-usable program code embodied in the medium.

Any combination of one or more computer-usable or computer-readable media may be utilized. For example, a computer-readable medium may include one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. Computer program code for carrying out operations of the present embodiments may be written in any combination of one or more programming languages.

The flowcharts and block diagrams in the flow diagrams illustrate the architecture, functionality, and operation of possible implementations of systems, methods, and computer program products according to various embodiments. In this regard, each block in the flowcharts or block diagrams may represent a module, segment, or portion of code, which comprises one or more executable instructions for implementing the specified logical function(s). It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowcharts and/or block diagrams.

Embodiments described herein disclose methods and systems to automatically transmit medical information to medical practitioners. The transmitted medical information may be a sub-set of information of a patient's medical health record that is desired to be viewed by the medical practitioner based on the medical practitioner's context, including but not limited to location, schedule, and/or the patient's medical status.

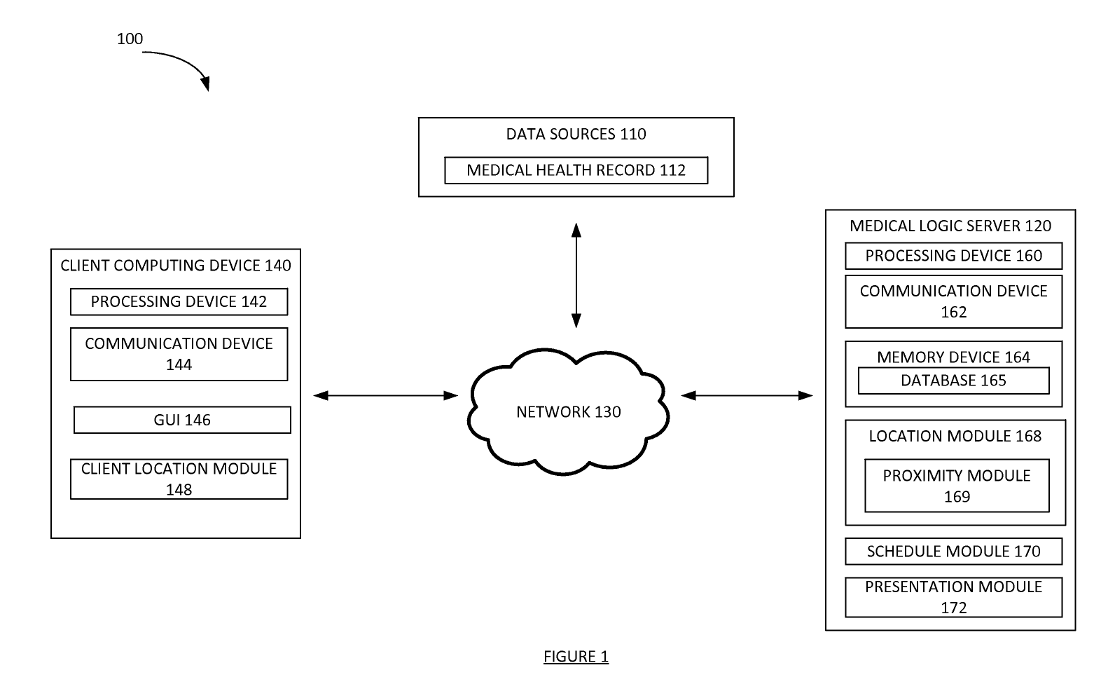

Turning now to FIG. 1, FIG. 1 depicts one topology 100 for automatically presenting medical information to a medical practitioner. Topology 100 may include data sources 110, medical logic server 120, client computing device 140, and network 130. The elements depicted in topology 100 may be communicatively coupled to each other over network 130.

Network 130 may be a wired or wireless network such as the Internet, an intranet, a LAN, a WAN, a cellular network or another type of network. It should be understood that network 130 may be a combination of multiple different kinds of wired or wireless networks.

Data sources 110 may be computing devices, such as a general hardware platform servers configured to receive and transmit information over network 130. In embodiments, data sources 110 may be associated medical care providers or medical information services. Each data source 110 may have an electronic health record 112 associated with at least one patient. Electronic health record 112 may include information associated with a patient, including, but not limited to: bibliographic information, demographic information, a picture of the patient, past or upcoming medical treatments for the patient, prescription drugs that the patient is currently taking or previously has taken, medical notes associated with the patient, the family of the patient's medical history, information obtained from medical equipment associated with the patient, a date, location, and/or time that a medical practitioner is scheduled to meet with the patient, the purpose the medical practitioner is scheduled to meet with the patent at the scheduled date, location and/or time, etc. In embodiments, each medical health record 112 may have the same and/or different information associated with a patient.

Medical logic server 120 may be a computing device, such as a general hardware platform server configured to support mobile applications, software, and the like executed on client computing device 140. Medical logic server 120 may include physical computing devices residing at a particular location or may be deployed in a cloud computing network environment. In this description and the following claims, “cloud computing” may be defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

Medical logic server 120 may include any combination of one or more computer-usable or computer-readable media. For example, medical logic server 120 may include a computer-readable medium including one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device.

In embodiments, medical logic server 120 may include a processing device 160, a communication device 162, a memory device 164, a clinical processor 166, location module 168, schedule module 170, and presentation module 172.

Processing device 160 may include memory, e.g., read only memory (ROM) and random access memory (RAM), storing processor-executable instructions and one or more processors that execute the processor-executable instructions. In embodiments where processing device 160 includes two or more processors, the processors may operate in a parallel or distributed manner. Processing device 160 may execute an operating system of medical logic server 120 or software associated with other elements of medical logic server 120.

Communication device 162 may be a device that allows medical logic server 120 to communicate with another device over network 130. Communication device 162 may include one or more wireless transceivers for performing wireless communication and/or one or more communication ports for performing wired communication. In embodiments, communication device 162 may be configured to receive electronic medical records 112 from data sources 110 and transmit medical information to client computing device 140. In further embodiments, communication device 162 may be configured to receive real-time information from medical computing devices (not shown) at a physical medical location, such as a hospital, emergency room, doctor's office etc. The received real-time information may be received from medical devices that are configured to monitor a patient, such as a heart monitor, blood pressure monitor, etc. Communication device 162 may also be configured to receive text based or audio based inputs from client computing device 140, and convert the audio inputs into text using voice-to-text processing. Responsive to receiving the inputs from client computing device 140, communication device 162 may conduct natural language processing on the received inputs to determine the medical practitioner's intent, and receive electronic health records 112 for a patient based on the received inputs.

Memory device 164 may be a device that stores data generated or received by medical logic server 120. Memory device 164 may include, but is not limited to a hard disc drive, an optical disc drive, and/or a flash memory drive. In embodiments, memory device 164 may be configured to store information received from client computing device 140 and/or data sources 110. The information stored within memory device 164 may be accessed by processing device 160, communication device 162, and/or modules 166, 168, 170, 172.

In embodiments, memory device 164 may include a database 165 configured to store medical information associated with a patient and/or information associated with a medical practitioner. The medical information associated with the patient may include electronic medical health records 112 received from data sources 110. In implementations, each patient may have a unique global identifier utilized to identify a patient. In embodiments, the medical information within database 165 associated with a patient may be analyzed and tagged with contextual identifiers. The contextual identifiers may be utilized to determine what information a medical practitioner desires to receive and when the medical practitioner desires to receive the information.

Database 165 may also include an entry with a unique global identifier associated with a medical practitioner. The unique global identifier associated with the medical practitioner may correspond with a specific client computing device 140, a login and password, biometric scanner, or any other known method to correspond an identifier with a medical practitioner. The entry within the database 165 associated with the medical practitioner may include a type of medical practitioner, the schedule of the medical practitioner, locations associated with the medical practitioner, preferences or settings associated with what medical information the medical practitioner desires to receive for different types of patients, and/or any information that may be utilized to tag medical information with contextual identifiers.

Clinical processor 166 may be configured to analyze received electronic medical health records 112 from at least one data source 110, determine a patient associated with the received electronic medical health records 112, determine a medical practitioner that may desire to receive medical information, and tag the information within the received electronic medical health record 112 with contextual identifiers. The contextual identifiers may be utilized to identify medical information that a medical practitioner may desire to view, such that the medical practitioner is not provided with a full medical history of the patient and is only presented with desired and/or required information associated with the patient. In embodiments, the contextual identifiers may identify the information that a medical practitioner may most frequently desire to be presented with based on best practices of the medical practitioners or any other desired standard, such as a name and/or picture of the patient. Accordingly, the contextual identifiers may be utilized to present information identifying a patient, symptoms, past procedures, etc. associated with the patient, such that the medical practitioner may quickly determine who the patient is. In embodiments, the contextual identifiers may be set via independent medical practitioners for at least one patient on client computing device 140. Therefore, a medical practitioner may determine what information is desired to be viewed by the medical practitioner. In further embodiments, the received information may be tagged with contextual identifiers automatically by default values associated with the reason the patient desired to visit the medical practitioner, the location of the patient, the globally unique identifier of the medical practitioner that the patient is scheduled to visit with, or with any other desired contextual identifiers. Therefore, if the patient is visiting the medical practitioner for a checkup associated with a first type of medical procedure, the contextual identifiers may identify a first set of information to be presented to the medical practitioner, wherein the first set of information is associated with the first type of medical procedure. Whereas, if the patient is visiting the medical practitioner for a checkup associated with a second type of medical procedure, the contextual identifiers may identify a second set of information to be presented to the medical practitioner, wherein the second set of information is associated with the second type of medical procedure.

The contextual identifiers may also be associated types of medical practitioners that may desire to view what medical information associated with their patients. For example, a medical practitioner that is a heart surgeon may desire to view a first set of medical information that is tagged with a first contextual identifier, a second medical practitioner that is a general practice doctor that may desire to view a second set of medical information that is tagged with a second contextual identifier. In further embodiments, a medical practitioner that is a nurse may desire to view a third set of medical information that is tagged with a third contextual identifier. In embodiments, the first, second, or third set of medical information may include the same information and/or different information. Furthermore, the contextual identifiers may be associated with what information to present to the medical practitioner responsive to other medical practitioners being in close proximity to the medical practitioner. For example, if it is determined that a doctor is in close proximity to a plurality of medical residents, then a first set of information may be tagged to be presented to the doctor and a second set of information may be tagged to be presented to the medical residents.

In embodiments, the contextual identifiers may be time based identifiers, where medical practitioners may desire to view medical information based on recent medical procedures. For example, if a patient recently had an x-ray taken, the medical information associated with the x-ray may be tagged with a time based contextual identifier, where any medical practitioner or all medical practitioners of a certain type may desire to view the medical information with the time based contextual identifier.

In embodiments, the contextual identifiers may be location based. The location based contextual identifiers may indicate information that a first medical practitioner at a first location may desire to be presented with, and the location based contextual identifiers may indicate information that a second medical practitioner at a second location may desire to be presented with. In embodiments, the first and second locations may be different floors of a building, rooms of a building, sections of a building, separate buildings, etc. Therefore, medical practitioners at different locations may simultaneously be presented with sets of information, wherein the sets of information may be the same or different information.

Location module 168 may be configured to receive information configured to determine a location of client computing device 140. Location module 168 may determine a location of client computing device 140 in response a medical practitioner's schedule, at set intervals, which may be any desired period of time (e.g., every 1/10th of a second, every second, every minute, every ten minutes, etc.), and/or responsive to receiving inputs by the medical practitioner from client computing device 140. Location module 168 may determine the location of client computing device 140 via any known means, such as a RTLS WiFi, radar, mobile device tracking, time distance of arrival (TDOA) signals, short wave radio, Bluetooth, etc. Responsive to determining the location of client computing device 140, location module 168 may store data associated with the location of client computing device 140 in memory device 164 along with a corresponding time stamp identifying the time that the location is determined. In further embodiments, location module 168 may be configured to determine that client computing device 140 is at specific location based on the location of client computing device 140 and/or the location of a building, room within a building, floor of a building, etc. stored within memory device 164. For example, location module 168 may compare the data associated with the location of client computing device 140 with the location of a building stored within memory device 164. If the location data of client computing device 140 matches location data of a specific medical building, location module 168 may determine that client computing device 140 is at the specific medical building.

In embodiments, location module 168 may include proximity module 169. Proximity module 169 may be configured to determine other medical practitioners that are in close proximity to client computing device 140 associated with a medical practitioner. Proximity module 169 may be configured to determine the locations of a plurality of computing devices associated with medical practitioners at a location, and determine the distance to the plurality of computing devices to client computing device 140. If any of the distances between the plurality of computing devices to client computing device 140 is below a distance threshold, then it may be determined that the medical practitioners associated with the client computing devices that are below the distance threshold to client computing device 140 are in close proximity to client computing device 140. If it is determined that a second client computing device is in close proximity to client computing device 140, then it may be determined that the medical practitioner associated with the second client computing device is traveling and/or working with the medical practitioner associated with client computing device 140.

Schedule module 170 may be configured to receive schedule information associated with a medical practitioner's schedule. The medical practitioner's schedule may include globally unique identifiers of the patients the medical practitioner may diagnosis and/or visit with, the location of the patients, and/or a time that the medical practitioner may visit a patient. The schedule information may be received from data sources 110 and/or input on a client computing device. For example, a medical practitioner's schedule over a time period may be determined responsive to receiving electronic health records associated with a plurality of patients from data sources 110. Each of the received electronic health records 112 may include schedule information corresponding to when the medical practitioner may visit the patient. Schedule module 170 may determine the medical practitioner's schedule over the time period as a composite of the received schedule information within the electronic health records 112 associated with different patients. Responsive to a time and/or location that the medical practitioner may visit a patient, medical information with contextual identifiers associated with the medical practitioner and the patient may be automatically pushed to client computing device 140. For example, five minutes before the schedule information indicates that the medical practitioner may visit a patient, information with contextual identifiers corresponding to the medical practitioner and the patient may be pushed to client computing device 140.

Presentation module 172 may be configured to transmit information with contextual identifiers to be presented on a graphical user interface of client computing device 140. In embodiments, the information with contextual identifiers corresponding to the medical practitioner and a patient may be automatically transmitted to client computing device 140, without receiving any commands or inputs on the client computing device 140.

Client computing device 140 may be a smart phone, tablet computer, laptop computer, wearable computer, personal data assistant, Google Glasses®, or any other type of mobile device with a hardware processor that is configured to process instructions and connect to network 130, one or more portions of network 130. Client computing device 140 may include processing device 142, communication device 144, and graphical user interface (GUI) 146, and/or client location module 148.

Processing device 142 may include memory, e.g., read only memory (ROM) and random access memory (RAM), storing processor-executable instructions and one or more processors that execute the processor-executable instructions. In embodiments where processing device 142 includes two or more processors, the processors may operate in a parallel or distributed manner. Processing device 142 may execute an operating system of client computing device or software associated with other elements of client computing device.

Communication device 144 may be a device that allows client computing device 140 to communicate with another device over network 130. Communication device 144 may include one or more wireless transceivers for performing wireless communication and/or one or more communication ports for performing wired communication. In embodiments, communication device 144 may be configured to transmit and/or receive medical information associated with a patient to or from medical logic server 120.

GUI 146 may be a device that allows a medical practitioner to interact with client computing device 140. While one GUI is shown, the term “graphical user interface” may include, but is not limited to being, a touch screen, a physical keyboard, a mouse, a heads up display, glasses, some form of eye ware augmented reality to the user, a microphone, and/or a speaker. GUI 146 may be configured to receive inputs, including audio and/or visual data, associated with a patient's medical information. The received inputs may be transmitted to medical logic server 120 over network 130. In embodiments, GUI 146 may be configured to automatically present contextual based information on GUI 146 without receiving inputs or commands. GUI 146 may be configured to receive audio inputs from a medical provider via a microphone, and GUI 146 may transmit the audio inputs to medical logic server 120. In further embodiments, GUI 146 may be configured to convert the audio input into a text based input utilizing voice-to-text processing.

Client location module 148 may be configured to determine a location of client computing device 140. In embodiments, client location module 148 may be configured to continuously determine the location data associated with the location of client computing device 140 without receiving commands or inputs from the user, and transmit the determined location data to medical logic server 120. The location data may be associated with and represented in geographic coordinates, Cartesian coordinates, name of a building, room number, etc. The location data may include information such as real-time locating system signals (RTLS), WiFi signals, GPS, Bluetooth, short range radio signals, etc.

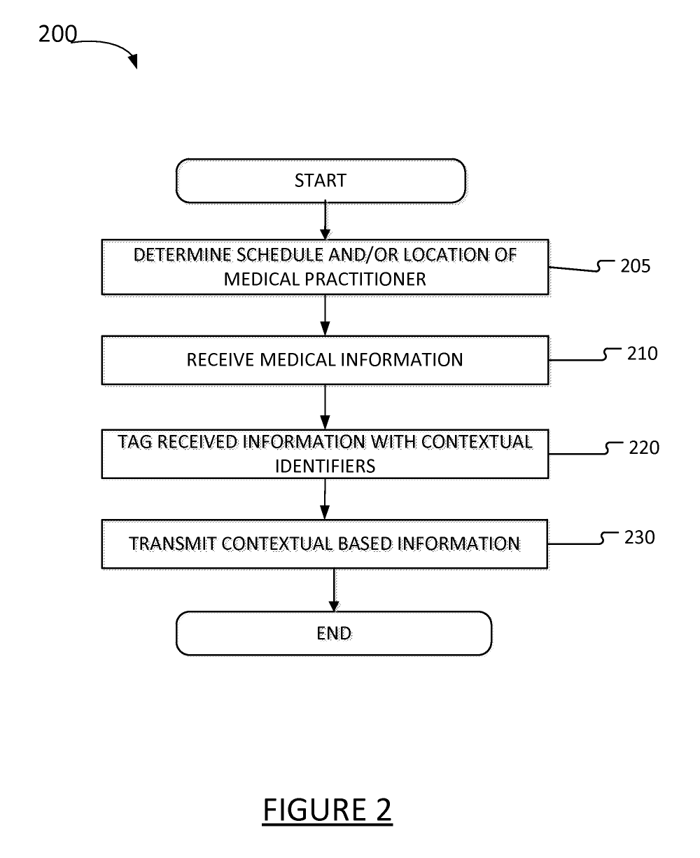

FIG. 2 illustrates a method 200 for presenting relevant and timely medical information to a medical practitioner. The operations of method 200 presented below are intended to be illustrative. In some embodiments, method 200 may be accomplished with one or more additional operations not described, and/or without one or more of the operations discussed. Additionally, the order in which the operations of method 200 are illustrated in FIG. 2 and described below is not intended to be limiting.

In some embodiments, method 200 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 200 in response to instructions stored electronically on an electronic storage medium. The one or more processing devices may include one or more devices configured through hardware, firmware, and/or software to be specifically designed for execution of one or more of the operations of method 200.

At operation 205, the schedule and/or the location of a medical practitioner may be determined. The schedule of the medical practitioner may be determined responsive to receiving inputs associated with a time and location that the medical practitioner may visit patients over a time period, receiving inputs to receive medical information, and/or receiving schedule information from within an electric health record associated with a patient. The received scheduled information with the electronic health record may include a date, location, and/or time that a medical practitioner is scheduled to meet with the patient and the purpose the medical practitioner is scheduled to meet with the patent at the scheduled date, location and/or time. The location of the medical practitioner may be determined responsive to receiving location data of a client computing device associated with the medical practitioner, and comparing the received location data with location data associated with patients, room numbers, buildings, floors, sections of a building, etc. Operation 205 may be performed by a schedule module and/or location module that are the same as or similar to schedule module 170 and/or location module 168, in accordance with one or more implementation.

At operation 210, electronic medical information may be received. The medical information may be received by receiving desired information associated with a patient, identifying a patient that a medical practitioner may visit, a patient that a medical practitioner is currently diagnosing, etc. The medical information may be received from at least one third party data source and/or a local medical monitoring computing system. In embodiments, the received medical information may or may not be a complete medical history associated with a patient, and may only include information that a medical practitioner at a specific location at a specific time may desire to view. If a medical practitioner desires to be presented with additional electronic medical information associated with a patient, the medical practitioner may input via voice commands that information that the medical practitioner desired to be presented with. Operation 210 may be performed by a communication device that is the same as or similar to communication device 162, in accordance with one or more implementation.

At operation 220, the data within the received electronic information associated with the patient may be tagged with contextual identifiers. The contextual identifiers may be utilized to identify medical information that a medical practitioner may desire to view, such that the medical practitioner is not provided with a full medical history of a patient and only desired and/or required information associated with the patient is presented to the medical practitioner. In embodiments, the contextual identifiers may be associated with specific medical practitioners, a type of medical practitioner, time based, location based, and/or based on the reason why the patient is visiting the medical practitioner. Operation 220 may be performed by a clinical processer that is the same as or similar to clinical processor 166, in accordance with one or more implementation.

At operation 230, contextual based information may be transmitted to the computing device associated with the medical practitioner without receiving commands input by the medical practitioner. The transmitted contextual information may be based on the medical practitioner's schedule, a time of day, the medical practitioner's location, the reasons the patient is visiting the medical practitioner, the location of the patient, and/or the contextual identifiers of the received information. If the medical practitioner's schedule corresponds to a time of day that the medical practitioner is going to view the patient and/or the location of the medical practitioner corresponds to a location of the patient, then the received information with contextual identifiers associated with the medical practitioner and the patient may be transmitted to a computing client device associated with the medical practitioner. Operation 230 may be performed by a presentation module that is the same as or similar to presentation module 172, in accordance with one or more implementation.

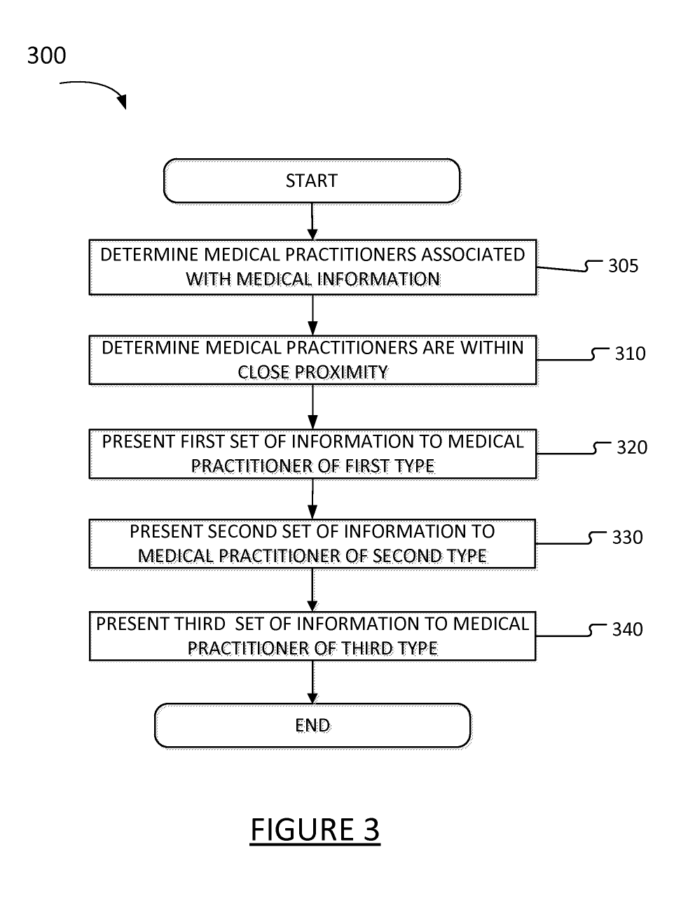

FIG. 3 illustrates a method 300 for presenting relevant and timely medical information to a medical practitioner. The operations of method 300 presented below are intended to be illustrative. In some embodiments, method 300 may be accomplished with one or more additional operations not described, and/or without one or more of the operations discussed. Additionally, the order in which the operations of method 300 are illustrated in FIG. 3 and described below is not intended to be limiting.

In some embodiments, method 300 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 300 in response to instructions stored electronically on an electronic storage medium. The one or more processing devices may include one or more devices configured through hardware, firmware, and/or software to be specifically designed for execution of one or more of the operations of method 300.

At operation 305, medical practitioners associated with a medical health record may be determined. The medical practitioners associated with the medical health record may be based on the type of medical practitioners required to perform a medical procedure. For example, a medical health record may indicate that a patient is visiting a hospital for a surgery requiring two surgeons, a nurse, and multiple residents will be watching the medical procedure. Operation 305 may be performed by a clinical processor that is the same as or similar to clinical processor 166, in accordance with one or more implementation.

At operation 310, the locations of the medical practitioners associated with the medical procedure may be determined at a time associated with the medical procedure. Responsive to determining the locations of the medical practitioners, it may be determined that the two surgeons, the nurse, and the residents are in close proximity to each other, and at a location associated with the medical procedure. Operation 310 may be performed by a location module that is the same as or similar to location module 160, in accordance with one or more implementation.

At operation 320, a first set of information may be presented to the surgeons. Where the first set of information may include medical information associated with the medical history of the patient, the medical procedure. Operation 320 may be performed by a clinical processor that is the same as or similar to clinical processor 166, in accordance with one or more implementation.

At operation 330, a second set of information may be presented to the nurse, wherein the second set of information may include information associated with the medical procedure, assessment of the patient during the medical procedure, tools required to perform the medical procedure, etc. Operation 330 may be performed by a clinical processor that is the same as or similar to clinical processor 166, in accordance with one or more implementation.

At operation 340, a third set of information may be presented to the residents, wherein the third set of information may include associated with the medical procedure, learning tools associated with the medical procedure, etc. In embodiments, the first, second, and third sets of information may include the same and/or different information, which may be relevant to the different types of medical practitioners. Operation 340 may be performed by a clinical processor that is the same as or similar to clinical processor 166, in accordance with one or more implementation.

Although the present technology has been described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

What is claimed is:

1. A system for presenting medical information to medical practitioners, the system comprising:
a communication device configured to receive a medical health record associated with a patient, the medical health record including information associated with the patient and contextual identifiers, wherein the contextual identifiers correspond to a subset of information within the medical health record;
a location module configured to determine medical practitioner location information associated with a location of a medical practitioner;
a schedule module configured to determine medical practitioner schedule information associated with a schedule of the medical practitioner; and
a presentation module configured to transmit the subset of information within the medical health record based on the medical practitioner location information and the medical practitioner schedule information.

2. The system of claim 1, wherein the contextual identifiers include medical practitioner type identifiers, wherein a first medical practitioner type is associated with a first subset of information within the medical health record, and a second medical practitioner type is associated with a second subset of information within the medical health record.

3. The system of claim 2, further comprising:
a clinical processor configured to determine a medical practitioner type of the medical practitioner, wherein the presentation module is configured to transmit the first subset of information within the medical health record or the second subset of information within the medical health record based on the medical practitioner type of the medical practitioner.

4. The system of claim 1, wherein the medical health record includes at least one of a picture of the patient, symptoms of the patient, allergies of the patient, or past medical procedures associated with the patient.

5. The system of claim 1, wherein the medical practitioner determines what information within the medical health record is within the subset of information.

6. The system of claim 1, wherein the location module is configured to determine when the medical practitioner location information is within a given distance to a location of the patient.

7. The system of claim 6, wherein the presentation module is configured to transmit the subset of information within the medical health record responsive to determining that the medical practitioner location information is within the given distance to the location of the patient.

8. The system of claim 1, wherein the medical practitioner schedule information is associated with a time that the medical practitioner is scheduled to meet with the patient.

9. The system of claim 8, wherein the presentation module is configured to transmit the subset of information within the medical health record before the time that the medical practitioner is scheduled to meet with the patient.

10. The system of claim 1, wherein the contextual identifiers include patient location information and patient schedule information, the patient location information being associated with where the patient is schedule to meet with the medical practitioner, and the patient schedule information being associated with when the patient is schedule to meet with the medical practitioner; and
the presentation device is configured to transmit the subset of information within the medical health record responsive to comparing the patient location information with the medical practitioner location information and the patient schedule information with the medical practitioner schedule information.

11. A method for presenting medical information to medical practitioners, the method comprising:
receiving a medical health record associated with a patient, the medical health record including information associated with the patient and contextual identifiers, wherein the contextual identifiers correspond to a subset of information within the medical health record;
determining medical practitioner location information associated with a location of a medical practitioner;
determining medical practitioner schedule information associated with a schedule of the medical practitioner; and
transmitting the subset of information within the medical health record based on the medical practitioner location information and the medical practitioner schedule information.

12. The method of claim 11, wherein the contextual identifiers include medical practitioner type identifiers, wherein a first medical practitioner type is associated with a first subset of information within the medical health record, and a second medical practitioner type is associated with a second subset of information within the medical health record.

13. The method of claim 12, further comprising:
determining a medical practitioner type of the medical practitioner; and
transmitting the first subset of information or the second subset of information based on the medical practitioner type of the medical practitioner.

14. The method of claim 11, wherein the medical health record includes at least one of a picture of the patient, symptoms of the patient, allergies of the patient, or past medical procedures associated with the patient.

15. The method of claim 11, wherein the medical practitioner determines what information within the medical health record is within the subset of information.

16. The method of claim 11, further comprising:
determining when the medical practitioner information is within a given distance to a location of the patient.

17. The method of claim 16, further comprising:
transmitting the subset of information within the medical health record responsive to determining that the medical practitioner location information is within the given distance to the location of the patient.

18. The method of claim 11, wherein the medical practitioner schedule information is associated with a time that the medical practitioner is scheduled to meet with the patient.

19. The method of claim 18, further comprising:
transmitting the subset of information within the medical health record before the time that the medical practitioner is scheduled to meet with the patient.

20. The method of claim 11, wherein the contextual identifiers include patient location information and patient schedule information, the patient location information being associated with where the patient is schedule to meet with the medical practitioner, and the patient schedule information being associated with when the patient is schedule to meet with the medical practitioner; and
transmitting the subset of information within the medical health record responsive to comparing the patient location information with the medical practitioner location information and the patient schedule information with the medical practitioner schedule information.
